(19) United States
(12) Patent Application Publication
(10) Pub. No.: US 2010/0214321 A1
(43) Pub. Date: Aug. 26, 2010

(54) IMAGE OBJECT DETECTION BROWSER

(75) Inventors: Mika Antero Hokkanen, Tokyo (JP); Matti Naskali, Tokyo (JP); Seppo Raisanen, Tokyo (JP)

Correspondence Address: Perman & Green, LLP, 99 Hawley Lane, Stratford, CT, 06614, US

(73) Assignee: NOKIA CORPORATION, Espoo (FI)

(21) Appl. No.: 12/391,365

(22) Filed: Feb. 24, 2009

(51) Int. Cl. G09G 5/00; G06K 9/62

(52) U.S. Cl. 345/660; 382/224

(57) ABSTRACT

At least one object in an image presented on a display of an apparatus is detected and image location data for each of the at least one object is obtained. Each detected object on the display is presented in a sequential fashion based the obtained image location data, where the image is panned on the display and a currently displayed object is resized by an image resizing module of the apparatus to be a focal point of the image.

### BACKGROUND

1. Field

The aspects of the disclosed embodiments generally relate to imaging in a device and more particularly to automatically detecting and displaying objects in an image displayed on a device.

2. Brief Description of Related Developments

An image displayed on a screen of a device can include one or more points of interest or features that might be of particular interest to the viewer. For example, pictures of people, and in particular, their faces, can be of interest to a viewer. However, in order to see faces in an image, particularly on a small screen device, it can be necessary to “zoom in” or focus on the face. This can require manual manipulation of the device to first locate and focus on the desired feature, and then zoom-in or enlarge the feature. Zooming in on a particular feature can be a slow and imprecise manual function. This can be especially problematic when trying to view faces in an image on a small screen device.

Although face detection algorithms are know, these algorithms concern detecting a face that is closest to a detection point. For example, in JP Pub. No. 2006-178222 to Fuji Photo Film Co Ltd., the image display program detects face information consisting of both eyes and positions of the eyes of all persons from an image displayed in an image display browser. A face region that is to be magnified is specified on the basis of a position of a face region that is closest to a detection point designated by a user, such as with the pointing device.

It would be advantageous to be able to easily automatically detect, browse and display points of interest or other desired objects in an image or set of images being displayed on a display of a device.

### SUMMARY

The aspects of the disclosed embodiments are directed to at least a method, apparatus, user interface and computer program product. In one embodiment the method includes detecting at least one object in an image presented on a display of an apparatus, automatically obtaining image location data for each of the at least one object and sequentially displaying the at least one detected object on the display based on the obtained image location data, where the image is panned on the display and a currently displayed object is resized by an image resizing module of the apparatus to be a focal point of the image.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an exemplary process including aspects of the disclosed embodiments;

FIGS. 3 and 4 illustrate exemplary devices that can be used to practice aspects of the disclosed embodiments;

FIG. 5 illustrates exemplary screen shots of a display illustrating aspects of the disclosed embodiments;

FIG. 6 illustrates another exemplary device that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 3 and 4 may be used.

### DETAILED DESCRIPTION OF THE EMBODIMENT(S)

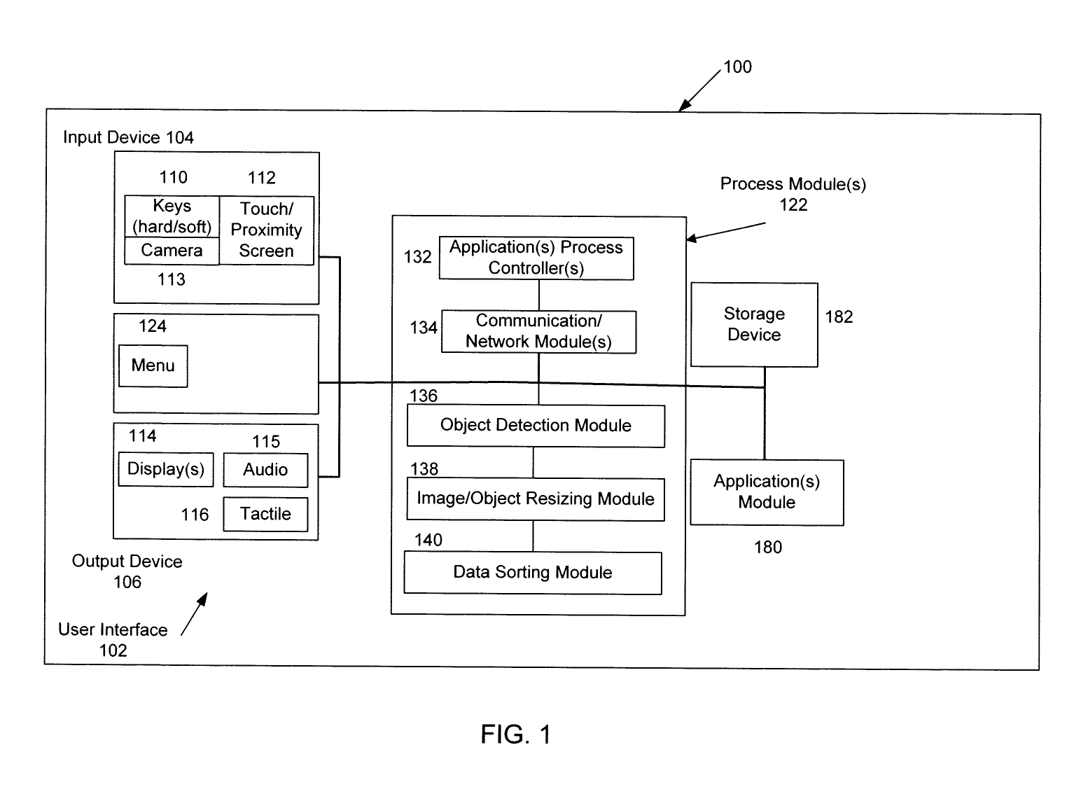

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide for improving image browsing and image object detection on a display 114 of the system 100. Known object detection, such as face detection algorithms, is used to find specific objects in an image. The data related to each detected object is used to zoom-in on, and browse the detected objects, either automatically or when requested by the user. The objects can be in one image or a series of images, such as a picture or a slide show. The system 100 recognizes or detects predetermined objects or points of interest in the image and displays each object in a pre-determined sequence. In one embodiment, the system 100 resizes the image on the display 114, and the detected object, so that the detected object is presented is the predominate feature shown on the display 114. Thus, the system 100 moves from object to object, displaying each object on the display sequentially, where object size is taken into account so that the displayed object is easily perceptible.

FIG. 1 illustrates one example of a system 100 incorporating aspects of the disclosed embodiments. Generally, the system 100 includes a user interface 102, process modules 122, applications module 180, and storage devices 182. In alternate embodiments, the system 100 can include other suitable systems, devices and components that allow for associating option menus with a title bar and allows for easy and quick identification and selection of the option menus. The components described herein are merely exemplary and are not intended to encompass all components that can be included in the system 100. The system 100 can also include one or more processors or computer program products to execute the processes, methods, sequences, algorithms and instructions described herein.

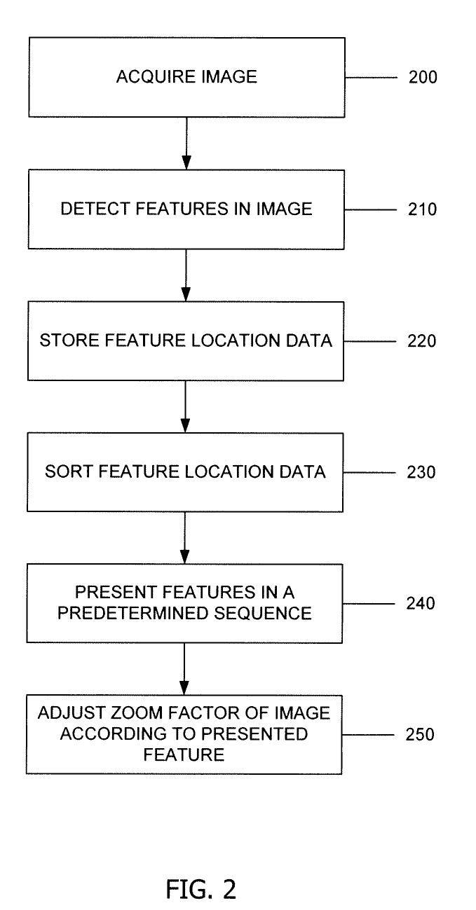

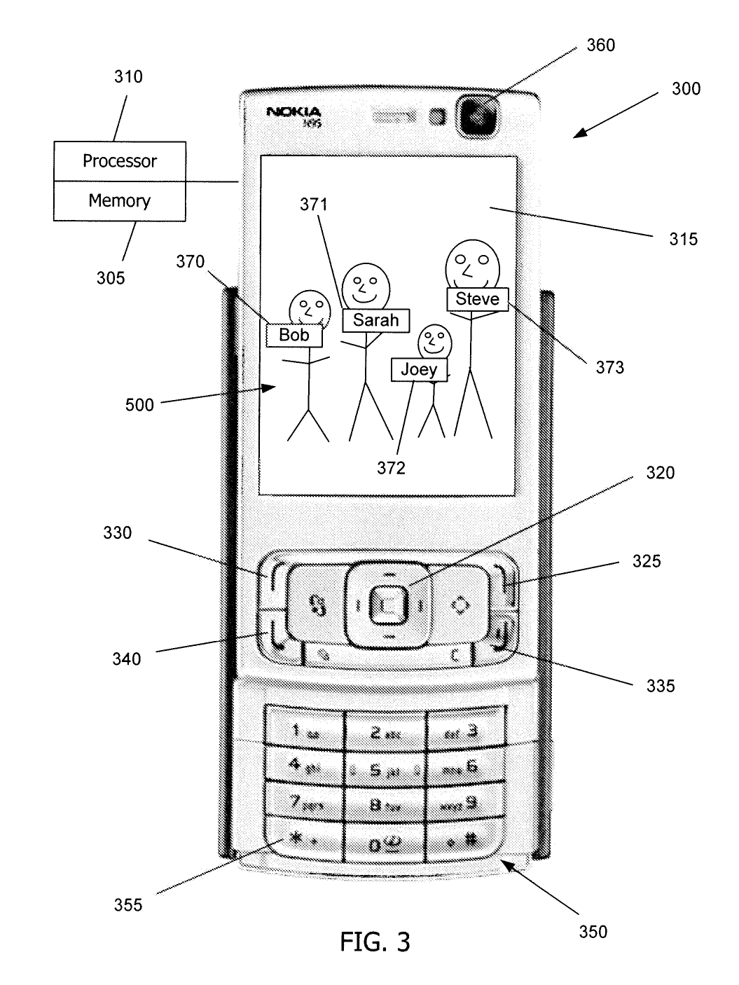

In one embodiment, the process module 122 includes an object or point of interest detection module 136, an image zooming/resizing module 138 and a data sorting module 140. In alternate embodiments, the process module 122 can include any suitable function and selection modules for use in displaying images. The image is acquired by the system 100 in any suitable manner (FIG. 2, Block 200). For example, the image may be acquired through a camera 113 or other imaging device of the system 100. In one embodiment, the image can be a file that is stored or uploaded to the system 100. In other examples, the image may be acquired over a network such as, for exemplary purposes only, the Internet. In one embodiment, the object detection module 136 is generally configured to detect any suitable object or feature(s) of the image, such as for example a face. (FIG. 2, Block 210). In this example, the object detection module 136 may include any suitable face detection algorithm for detecting the faces in the image. It is noted that while a face detection algorithm is described herein, the object detection module 136 may include other recognition algorithms for detecting any suitable object(s) or feature(s) of the image. For exemplary purposes only, the disclosed embodiments will be described with respect to the detection of faces of people or animals in an image. However, it should be understood that the object detection module 136 is not limited to the detection of faces but may be configured to detect any suitable feature of the image. For example, the system 100 may include a menu associated with the object detection module 136 that presents options to a user for determining which objects in the image are to be detected. For example, the system 100 may allow for the tagging of objects of interest in the image. The objects may be tagged in any suitable manner such as through a touch screen 112 capability of the system and/or through use of the keys 110 of the system. In one embodiment, an image feature may be tagged by placing a cursor or other suitable pointer over or adjacent to the image and selecting the image by, for example, tapping/touching a touch screen 112 of the system 100 or by activation of any suitable key 110 of the system 100. Any suitable information may be attached to the object through the tag such as a persons name, an address of a building, etc. Examples of tags 370-373 are shown in FIG. 3, where the tags represent the names of the people in the image. In one example, the tagged objects are detected by the object detection module 136 in any suitable manner such as, for exemplary purposes only, when each object is tagged or after tagging of the objects is completed.

The object detection module 136 is also configured to determine object location data related to each detected object. The determined location data may be stored by the object detection module 136 in any suitable storage facility, such as for example storage device 182 (FIG. 2, Block 220). The object location data may include any suitable data pertaining to each detected object such as, for example, the location of the object(s) and/or sizes of the object(s) in the image. In the situation where the detected objects are faces, the location of each face in the image will be determined and stored.

Based upon the detection of the objects in the image, the data sorting module 140 can be activated. The data sorting module 140 is generally configured to sort the object location data in any suitable manner so that the detected objects, such as faces, can be re-presented on the display in a predetermined sequence. In one embodiment the data sorting module 140 sorts the object location data so that the object located closest to the top left corner of the viewing area of the display 114 is presented first and the object located closest to the bottom right corner of the viewing area of the display 114 is presented last, with intervening objects being presented sequentially in the order in which they appear when moving from the upper left to the bottom right of the display 114. In other non-limiting examples, the objects may be presented sequentially from left to right, right to left, top to bottom, bottom to top or diagonally in any suitable direction. In yet another example, the objects may be presented in a random sequence. Where the objects are tagged, as described above, the data sorting module 140 may be configured to present the objects in the order in which they were tagged. In another example, the data sorting module 140 may be configured to present the tagged objects according to the information included in the tag. In one embodiment, the tagged objects may be presented alphabetically or in any suitable sequence dependent on the tag information.

In one embodiment, the system 100 includes a menu associated with the data sorting module 140 that presents options to the user for determining the sequence in which the objects are presented on the display 114.

In one embodiment, the process module 122 also includes an image/object resizing module 138. The image/object resizing module 138 is configured to pan or smoothly move a visible or displayed portion of the image on the display 114 so that each object is sequentially presented as the focal point of the image on the display 114. As a non-limiting example, when an object is presented as the focal point of the image, the image may be panned so that the object is substantially centered on the display 114. In one embodiment the image resizing module 138 is configured to adjust the size or scale of the image (e.g. zoom in or out) so that each object is presented as the predominate feature on the display. For example, when the detected objects are faces, as faces are presented in the predetermined sequence (FIG. 2, Block 240), image resizing module 138 pans the displayed portion of the image to, for example, a first face in the sequence of faces and the image and face size is adjusted to zoom-in on or zoom-out on the first face, depending on the size of the first face, so that the first face is predominately shown on the display 114 (FIG. 2, Block 250). When displaying a second face in the sequence of faces the image resizing module 138 may smoothly pan the displayed portion of the image to the second face and adjust the image and/or face size so that the second face is predominately shown on the display 114. For each face in the remaining faces in the sequence of faces, the image and faces are resized accordingly. In this example, the panning and scaling of the image occurs automatically. In another embodiment, the resizing or scaling of the image may be selectively activated through activation of a suitable input device 104 of the system as each of the faces is displayed as the focal point. In one example, as a face is presented as the focal point of the image the system 100 may present a prompt inquiring as to whether the image is to be scaled so that the face predominately fills the viewable portion of the display 114. In another example, the resizing or scaling of the image may be activated through a soft key function of the system 100. In one embodiment, the image resizing module 138 is configured to calculate an image resizing factor (e.g. zooming factor) for displaying each face in the sequence of faces in any suitable manner. In one embodiment, the image resizing factor may be calculated from face size information obtained from the face detection algorithm of the object detection module 136.

While the examples described herein are described with respect to detecting features of a single image presented on the display of a device, it is noted that the object detection module 136 may be configured to detect objects from a single image, or several images, such as a group of, or database of images. In one embodiment, the object detection module 136 may be configured to detect objects in one or more images that are not presented on the display such as when, for example, detecting objects of a group of images stored in a memory. In one embodiment, the object detection module 136 may be configured to scan files stored in, for example, the storage device 182 or an external storage device. The scanning of the image files may occur upon detection of an activation of an input device 104 of the system 100 or at any other suitable time, such as periodically. In another embodiment, the object detection module 136 is configured to detect objects in an image as the image is acquired by the system 100. For example, as an image is acquired by a camera 113 of the system 100 and saved in, for example, storage device 182, the acquisition of the image may activate the object detection module 136 for detecting objects in the newly acquired image.

One non-limiting example of a device 300 on which aspects of the disclosed embodiments can be practiced is illustrated with respect to FIG. 3. The device is merely exemplary and is not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

As shown in FIG. 3, in one embodiment, the device 300 is shown as a mobile communications device having a display area 315 and a keypad 350. The keypad 350 may include any suitable user input functions such as, for example, a multi-function/scroll key 320, soft keys 325, 330, call key 340, end call key 335 and alphanumeric keys 355. In one embodiment, the device 300 can include an image capture device 360 such as a camera as a further input device.

The display 315 may be any suitable display, and can also include a touch screen display or graphical user interface. The display may be integral to the device 300 or the display may be a peripheral display connected or coupled to the device 300. A pointing device, such as for example, a stylus, pen or simply the user's finger may be used in conjunction with, for example, a touch sensitive area of the display for cursor movement, menu selection, gestures and other input and commands. In alternate embodiments any suitable pointing or touch device, or other navigation control may be used. In other alternate embodiments, the display may be a conventional display. The device 300 may also include other suitable features such as, for example a loud speaker, tactile feedback devices or connectivity port. The device 300 may have a processor 310 connected or coupled to the display for processing user inputs and displaying information on the display 315. A memory 305 may be connected to the processor 310 for storing any suitable information, data, settings and/or applications associated with the device 300.

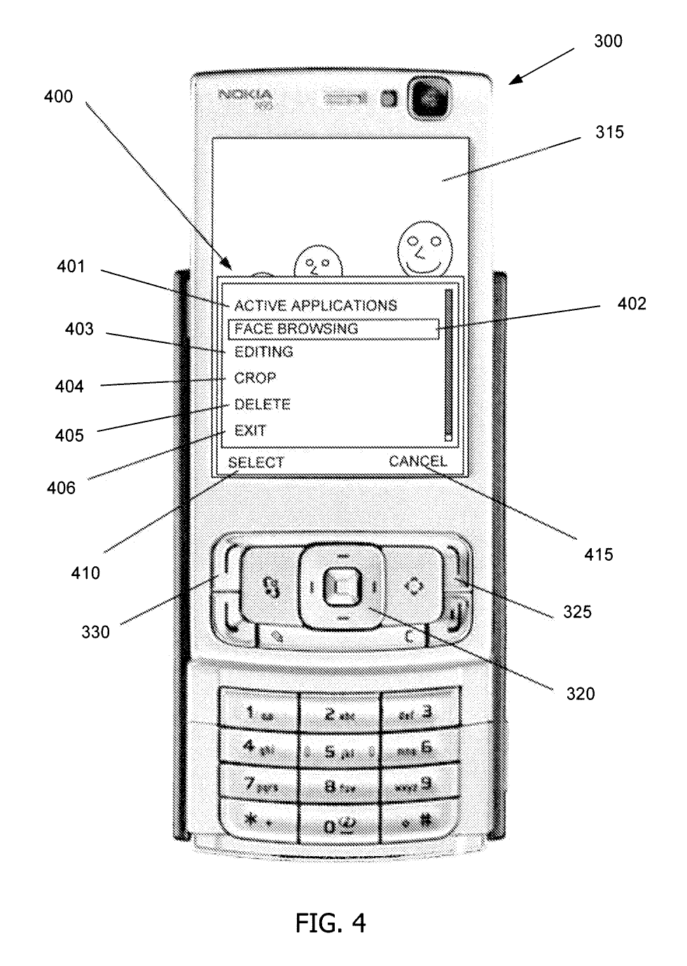

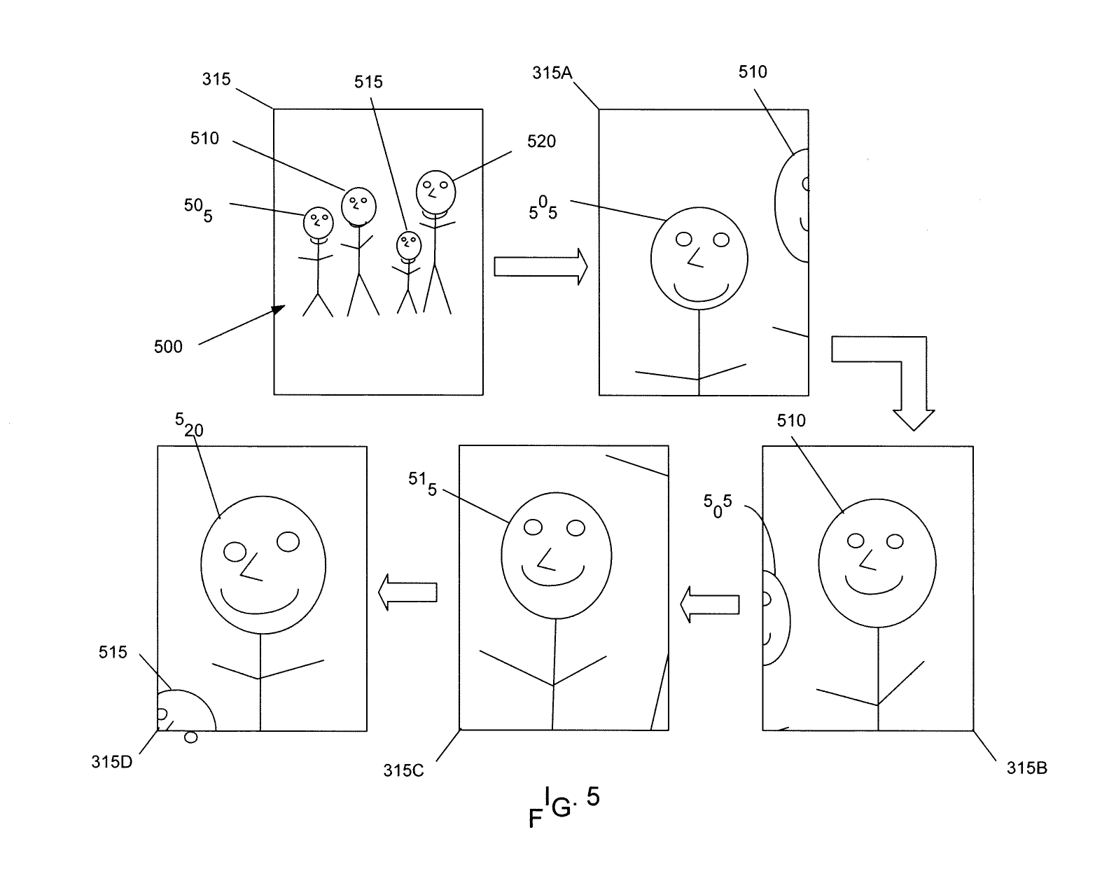

As can be seen in FIG. 3 a screen shot of an image having four (4) people is shown on the display 315. Referring also to FIG. 4, a menu 400 may be presented on the display 315 allowing for the browsing of the detected objects, which for exemplary purposes only, are the faces 505, 510, 515, 520 (FIG. 5) in a manner such as that described above with respect to FIG. 2. In one embodiment, the menu 400 may be presented in any suitable manner, such as by activating one of the keys of the device 300. The menu 400 may include any suitable selections pertaining to, for example, the operation of the device 300. In this example, the menu includes image editing or viewing commands 402-406, a link 401 to other active applications running on the device 300 and soft keys selections 410, 415 for selecting a menu item or canceling the menu 400. In one embodiment, the face browsing function 402 as described herein may be selected through, for example, use of the multi-function/scroll key 320 or in any other suitable manner such as through a touch screen feature of the display 315. In alternate embodiments, the face browsing function may be activated through a dedicated key (or soft key) of the device 300 or through voice commands.

FIG. 5 shows exemplary screen shots of face browsing described herein. Selection of the face browsing menu item 402 activates the object detection module 136 (FIG. 1) for detecting faces 505, 510, 515, 520, together with any other desired objects in the image 500. The object location data for the faces 505, 510, 515, 520, and/or any other suitable data, is determined and stored in, for example, the memory 305. The location data is sorted by the data sorting module 140 (FIG. 1) in the manner described above. In this example, the data sorting module 140 is configured to sort the object location data so that the faces can be displayed sequentially from left to right. As can be seen in FIG. 5, the view of image 500 is panned or smoothly moved so that the face 505 is substantially centered on the display 315A. The face and image are also scaled and resized so that the face 505 substantially fills the display 315A, and is the predominate feature presented on the display 315A. As the next face 510 is selected for presentation, which can be selected manually or automatically, the view of image 500 is panned away from the face 505 to face 510 and face 510 is substantially centered on the display 315B. As can be seen in FIG. 5, the image 500 and/or face 510 is resized (either enlarged/zoomed in or reduced/zoomed out depending on the size of the face) so that the face 510 substantially fills the display 315B. Similarly, when the third face 515 is selected, the view of image 500 is panned away from the face 510 and the image 500 and/or face 510 is resized so that the face 515 is substantially centered and presented as the predominate feature of the display 315C. The same process occurs with respect to the fourth face 520. In one embodiment, the panning of the image 500 for moving from one face to another face in the sequence of faces can be manual or automatic. For example, the image resizing module 138 may be configured to cause the panning/resizing of the image 500 and/or object to occur after a predetermined amount of time that may be settable through a menu of the device 300. In other embodiments, the image resizing module 138 may be configured to cause the panning/resizing of the image 500 to occur upon activation of, for example, any suitable key (or a touch of a touch screen) of the device 300. In alternate embodiments, panning/resizing of the image 500 may occur in any suitable manner.

Referring back to FIG. 1, the input device(s) 104 are generally configured to allow a user to select and input data, instructions, gestures and commands to the system 100. In one embodiment, the input device 104 can be configured to receive input commands remotely or from another device that is not local to the system 100. The input device 104 can include devices such as, for example, keys 110, a touch sensitive area or screen 112 and menu 124. The menu may be any suitable menu such as, for example, a menu substantially similar to menu 400 shown in FIG. 4. The input device 104 could also include a camera device 113 or other such other image capturing system. In alternate embodiments the input device can comprise any suitable device(s) or means that allows or provides for the selection, input and capture of data, information and/or instructions to a device, as described herein.

The output device(s) 106 are configured to allow information and data, such as the image and object(s) referred to herein, to be presented to the user via the user interface 102 of the system 100. The output device(s) can include one or more devices such as, for example, a display 114, audio device 115 or tactile output device 116. In one embodiment, the output device 106 is configured to transmit or output information to another device, which can be remote from the system 100. While the input device 104 and output device 106 are shown as separate devices, in one embodiment, the input device 104 and output device 106 are combined into a single device, and be part of and form, the user interface 102. For example, a touch sensitive area of the display 315 in FIG. 3 can also be used to present information in the form of the keypad elements resembling keypad 350. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers, image browsers and maps. In alternate embodiments, the applications module 180 can include any suitable application. The communication module 134 shown in FIG. 1 is generally configured to allow the device to receive and send communications and messages, such as text messages, chat messages, multimedia messages, still images, video and email, for example. The communications module 134 is also configured to receive information, data and communications from other devices and systems or networks, such as for example, the Internet. In one embodiment, the communications module 134 is configured to interface with, and establish communications connections with the Internet.

In one embodiment, the applications module 180 can also include a voice recognition system that includes a text-to-speech module that allows the user to receive and input voice commands, prompts and instructions, through a suitable audio input device. The voice commands may be used to perform the image object browsing as described herein in lieu of or in conjunction with one or more menus of the system 100.

The user interface 102 of FIG. 1 can also include menu systems 124 coupled to the process module 122 for allowing user input and commands and enabling application functionality. The process module 122 provides for the control of certain processes of the system 100 including, but not limited to the controls for detecting and determining gesture inputs and commands. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100. Depending on the inputs, the process module 122 interprets the commands and directs the process control 132 to execute the commands accordingly in conjunction with the other modules.

Referring to FIGS. 1 and 3, in one embodiment, the user interface of the disclosed embodiments can be implemented on or in a device that includes a touch sensitive area, touch screen display, proximity screen device or other graphical user interface.

In one embodiment, the display 114 is integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

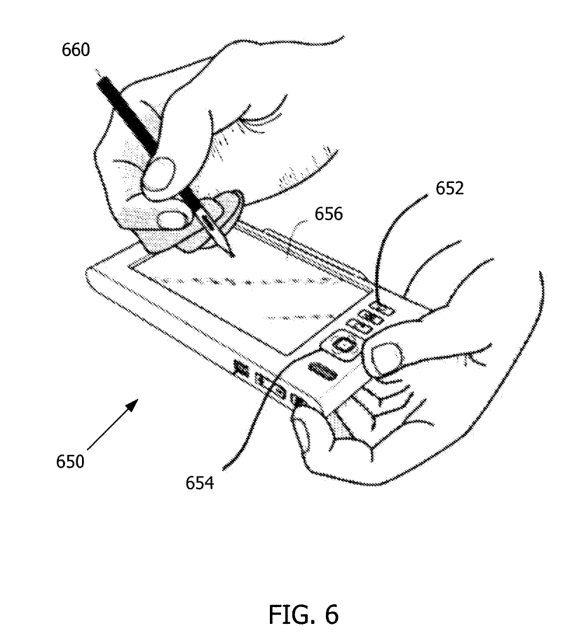

Although the embodiments described herein are described as being implemented on and with a mobile communication device, such as device 300, it will be understood that the disclosed embodiments can be practiced on any suitable device incorporating a processor, memory and supporting software or hardware. For example, the disclosed embodiments can be implemented on various types of music, gaming, multimedia devices, Internet enabled or any other device capable of displaying images on a display of the device. In one embodiment, the system 100 of FIG. 1 may be for example, a personal digital assistant (PDA) style device 650 illustrated in FIG. 6. The personal digital assistant 650 may have a keypad 652, cursor control 654, a touch screen display 656, and a pointing device 660 for use on the touch screen display 656. In still other alternate embodiments, the device may be a camera, a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) player or high definition media player or any other suitable device capable of containing for example a display 114 shown in FIG. 1, and supported electronics such as the processor 418 and memory 420 of FIG. 4A.

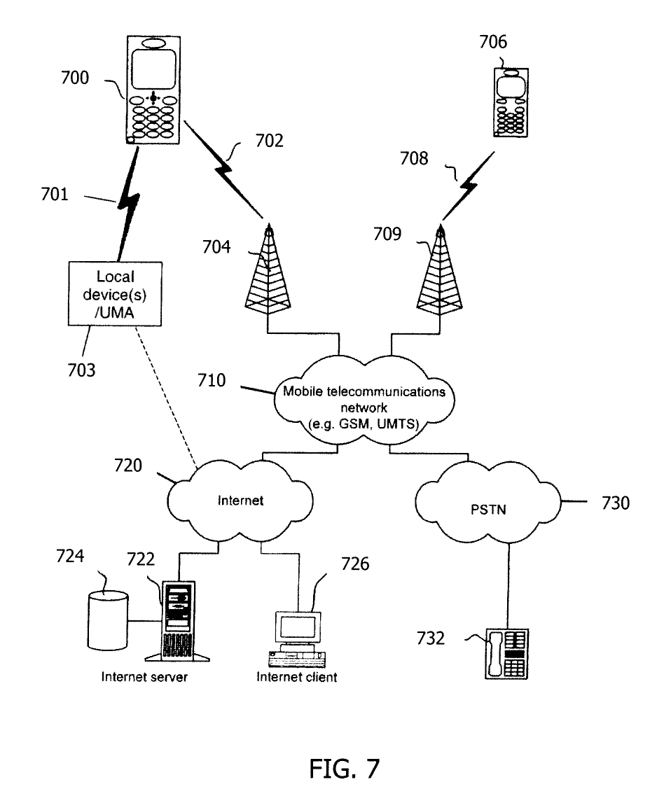

In the embodiment where the device 300 (FIG. 3) comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a personal computer (Internet client) 726 and/or an internet server 722.

It is to be noted that for different embodiments of the mobile device or terminal 700, and in different situations, some of the telecommunications services indicated above may or may not be available. The aspects of the disclosed embodiments are not limited to any particular set of services or communication, protocol or language in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide-area network 720, which may be the Internet or a part thereof. An Internet server 722 has data storage 724 and is connected to the wide area network 720. The server 722 may host a worldwide web/wireless application protocol server capable of serving worldwide web/wireless application protocol content to the mobile terminal 700. The mobile terminal 700 can also be coupled to the Internet 720. In one embodiment, the mobile terminal 700 can be coupled to the Internet 720 via a wired or wireless link, such as a Universal Serial Bus (USB) or Bluetooth™ connection, for example.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)).

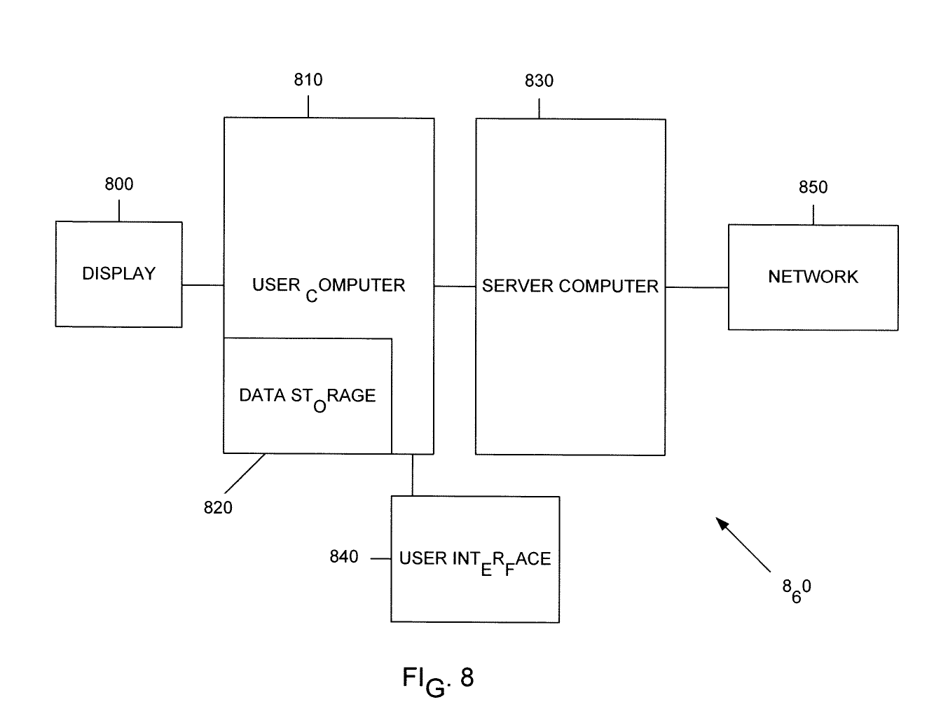

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 860 incorporating features that may be used to practice aspects of the invention. The apparatus 860 can include computer readable program code means for carrying out and executing the process steps described herein. In one embodiment computer readable program code is stored in a program storage device, such as a memory of the device. In alternate embodiments the computer readable program code can be stored in a memory medium that is external to, or remote from, the apparatus 860. The memory medium can be direct coupled or wirelessly coupled to the apparatus 860. As shown, a computer system 830 is linked to another computer system 810, such that the computers 830 and 810 are capable of sending information to each other and receiving information from each other. In one embodiment, computer system 830 could include a server computer adapted to communicate with a network 850. Alternatively, where only one computer system is used, such as computer 810, computer 810 will be configured to communicate with and interact with the network 850. Computer systems 830 and 810 can be linked together in any conventional manner including, for example, a modem, wireless, hard wire connection, or fiber optic link. Generally, information can be made available to both computer systems 830 and 810 using a communication protocol typically sent over a communication channel or other suitable connection or line, communication channel or link. In one embodiment, the communication channel comprises a suitable broad-band communication channel. Computers 830 and 810 are generally adapted to utilize program storage devices embodying machine-readable program source code, which is adapted to cause the computers 830 and 810 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 830 and 810 may also include a microprocessor for executing stored programs. Computer 810 may include a data storage device 820 on its program storage device for the storage of information and data. The computer program or software incorporating the processes and method steps incorporating aspects of the disclosed embodiments may be stored in one or more of the computers 830 and 810 on an otherwise conventional program storage device. In one embodiment, computers 830 and 810 may include a user interface 840, and/or a display interface 800 from which aspects of the invention can be accessed. The user interface 840 and the display interface 800, which in one embodiment can comprise a single interface, can be adapted to allow the input of queries and commands to the system, as well as present the results of the commands and queries, as described with reference to FIG. 1, for example.

The aspects of the disclosed embodiments provide for browsing and displaying one or more objects of an image and adjusting the scale of an image to obtain, for example, a detailed view of the one or more features. The scaling factor of the image for each of the one or more features is dependent on a size of a respective feature so that an entirety of the respective feature is presented on the display 114. The one or more features may be presented in any suitable manner. The portion of the image corresponding to each of the one or more object is focused on the display 114 for any suitable length of time. The one or more image objects may be “scrolled” through automatically (e.g. each object is presented on the display for a predetermined amount of time) or manually such as with user activation of an input device 104.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting a plurality of objects from among multiple objects in an image; and
causing the plurality of objects to be displayed sequentially wherein said displaying an object comprises resizing at least a part of the image so as to make at least one of the detected objects a focal point of the image.

2. The method of claim 1 wherein the at least one of the detected objects is a face in the image.

3. The method of claim 1 wherein the plurality of objects is sequentially displayed in at least one of a left to right sequence, a right to left sequence, a top to bottom sequence, a bottom to top sequence, a diagonal sequence, a sequence depending on information included in a tag associated with a respective object and in a random sequence.

4. The method of claim 1, wherein the at least one of the detected objects is presented as the focal point of the image for a predetermined length of time before presenting a next object.

5. The method of claim 1, wherein an image resizing device scales at least the part of the image so that the currently displayed object occupies substantially all of a viewing area of the display.

6. The method of claim 5, wherein the scaling of the currently displayed object occurs automatically as each object is presented as the focal point of the image.

7. The method of claim 1, wherein sequentially displaying includes panning the image and automatically displaying each detected object for a pre-determined time period before panning to a next detected object.

8. The method of claim 7 further comprising zooming-in on each detected object as each detected object is displayed.

9. The method of claim 1, further comprising sorting the image data with a sorting module wherein the sorted image data specifies a location in the image of each of the at least one object and a sequence in which the at least one object is displayed.

10. An apparatus comprising:
a display unit; and
at least one processor, the at least one processor being configured to:
detect a plurality of features of an image presented on the display unit; and
cause the plurality of detected features to be sequentially displayed on the display unit wherein displaying a detected feature includes automatically resizing at least part of the image so as to make the detected feature a focal point of the image.

11. The apparatus of claim 10, wherein at least one of the plurality of detected features is a face in the image.

12. The apparatus of claim 10, wherein the detected plurality of features are sequentially displayed in at least one of a left to right sequence, a right to left sequence, a top to bottom sequence, a bottom to top sequence, a diagonal sequence, a sequence depending on information included in a tag associated with a respective object and in a random sequence.

13. The apparatus of claim 12, where the processor is further configured to present each one of the features as the focal point of the image for a predetermined length of time.

14. The apparatus of claim 10, wherein the processor is further configured to scale the at least part of the image so that the currently displayed feature is predominately presented on the display unit.

15. The apparatus of claim 14, wherein the processor is further configured to automatically scale the at least part of the image as each of the plurality of features is presented as the as the focal point of the image.

16. The apparatus of claim 14, wherein the apparatus further comprises an input device, the processor being further configured to selectively scale the at least part of the image depending on a detection of an activation of the input device as each of the plurality of features is presented as the focal point of the image.

17. The apparatus of claim 10, wherein the processor is further configured to sort location data of each detected feature within the image, and cause sequential displaying of each of the detected features based on the sorting order.

18. The apparatus of claim 17, wherein the processor is further configured to determine a scaling factor for scaling the at least part of the image based on a size of the currently displayed feature, the size of the currently displayed feature being obtained from the location data of the detected feature within the image.

19. The apparatus of claim 10, wherein the apparatus comprises a mobile communication device.

20. A computer program product comprising a computer readable storage medium configured to execute the method according to claim 1.

21. The method of claim 1, wherein a location data of each detected object within the image is automatically obtained and each of the detected plurality of objects is sequentially displayed based on respective location within the image.

22. The apparatus of claim 11, wherein a location data of each detected feature within the image is automatically detected and each of the detected plurality of features are sequentially displayed based on a respective location within the image.

23. An apparatus comprising:
means for detecting a plurality of objects from among multiple objects in an image; and
means for causing the plurality of detected objects to be displayed sequentially, wherein displaying an object includes automatically resizing the detected object so as to make the detected object a focal point of the image.

24. An apparatus configured to perform the method as claimed in claim 1.
